(19) United States
(12) Patent Application Publication
(10) Pub. No.: US 2020/0015433 A1
(43) Pub. Date: Jan. 16, 2020

(54) LANDSCAPING GROUND COVER

(71) Applicant: Randall J. Meert, Elkhart, IN (US)

(72) Inventor: Randall J. Meert, Elkhart, IN (US)

(21) Appl. No.: 16/507,103

(22) Filed: Jul. 10, 2019

Related U.S. Application Data
(60) Provisional application No. 62/696,275, filed on Jul. 10, 2018.

(51) Int. Cl. A01G 13/02

(52) U.S. Cl. CPC A01G 13/0268; A01G 13/0281

(57) ABSTRACT

The ground cover includes a planar fabric body, a cover flap, and a pair of side rods. The cover body has a single slit that extends to its center to allow the ground cover to completely wrap around the base of the plant and lay flat over th ground. The cover flap is sewn or bonded to the cover body and folds to lay flat over the cover body in two positions, either folded to lie on one side of the slit or covering the slit. The side rods allow the ground cover to be easily lifted to deposit collected leaves and clippings into a collection container.

This application claims the benefit of U.S. Provisional Application No. 62/696,275 filed Jul. 10, 2018, the disclosure of which is hereby incorporated by reference.

This invention relates to drop cloths or ground covers, and in particular drop cloths and ground covers used for collecting and gathering pruned clippings and debris from around plants.

### SUMMARY AND BACKGROUND OF THE INVENTION

Removable drop clothes and ground covers are often used to collect leaves and clippings that fall on the ground from pruning and trimming bushes and trees. A common problem with most conventional drop cloths and ground covers is that they are difficult for a single user to handle or maneuver after they have been filled with debris. Moreover, most conventional drop cloths and ground cover are unwieldy and cannot be easily lifted to deposit the collected clippings into a separate container.

The ground cover of this invention allows users to collect and gather leaves and clipping pruned or falling from a tree, bush or plant and then easily lift and deposit those leaves and clippings in another collection container or bin. The ground Cover includes a planar fabric body, a cover flap, a pair of side rods. The cover body has a single slit that extends to its center to allows the ground cover to completely wrap around the base of the plant and lay flat over the ground. The cover flap is sewn or bonded to the cover body and folds to lay flat over the cover body in two positions, either folded to lie on one side of the slit or covering the slit. The side rods allow the ground cover to be easily lifted to deposit collected leaves and clippings into a collection container. One side rod is a two piece member that is detachable to position the cover body around the base of the tree or bush and easily reconnected to manipulate the cover and collected leaves and clippings.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is an exploded perspective view of an exemplary embodiment of the landscaping ground cover of this invention:

FIG. 2 is a perspective view of the ground cover of FIG. 1 being positioned around a tree;

FIG. 3 is a perspective view of the ground cover of FIG. 1 being positioned around the tree with the detachable rods connected;

FIG. 4 is is a perspective view of the ground cover of FIG. 1 being positioned around the tree with the cover flap folding over the slit;

FIG. 5 is a perspective view of the ground cover of FIG. 1 positioned around the tree collecting leaves and clippings;

FIG. 6 is a perspective view of the ground cover of FIG. 1 positioned around the tree with the cover flap folded back to gather leaves and clippings;

FIG. 7 is a perspective view of the ground cover of FIG. 1 pulled back from around the tree with the cover flap folded over the slit and the detachable rods reconnected;

FIG. 8 is a perspective view of the ground cover of FIG. 1 with the side rods being gathered together;

FIG. 9 is a perspective view of the ground cover of FIG. 1 depositing the leaves and clippings into a collection container; and

FIG. 10 is a perspective view of the ground cover of FIG. 1 hung in a storage position.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

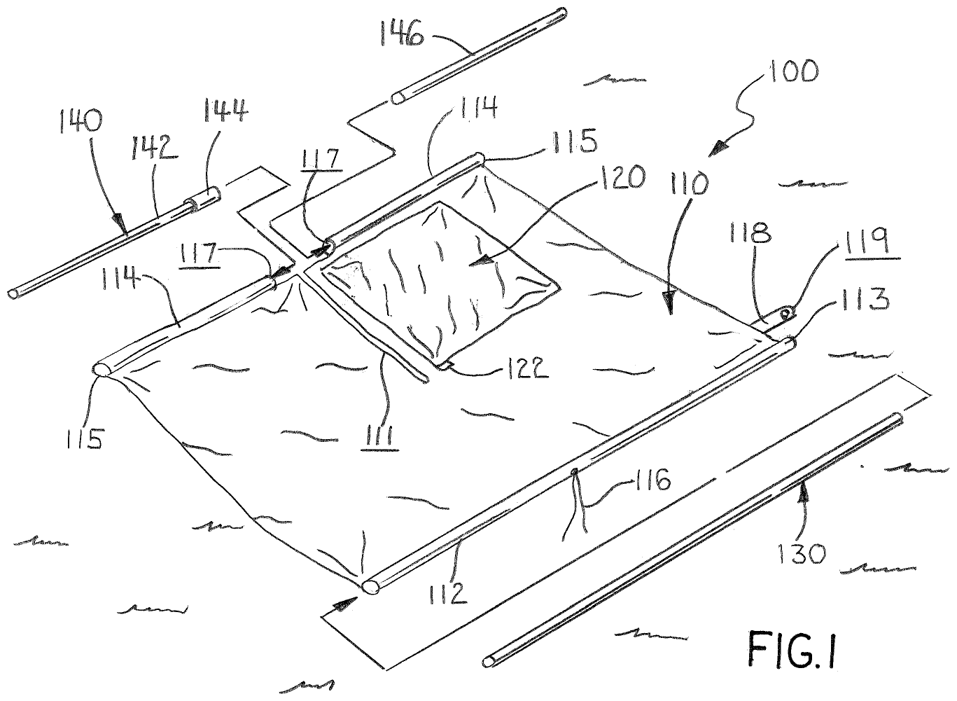

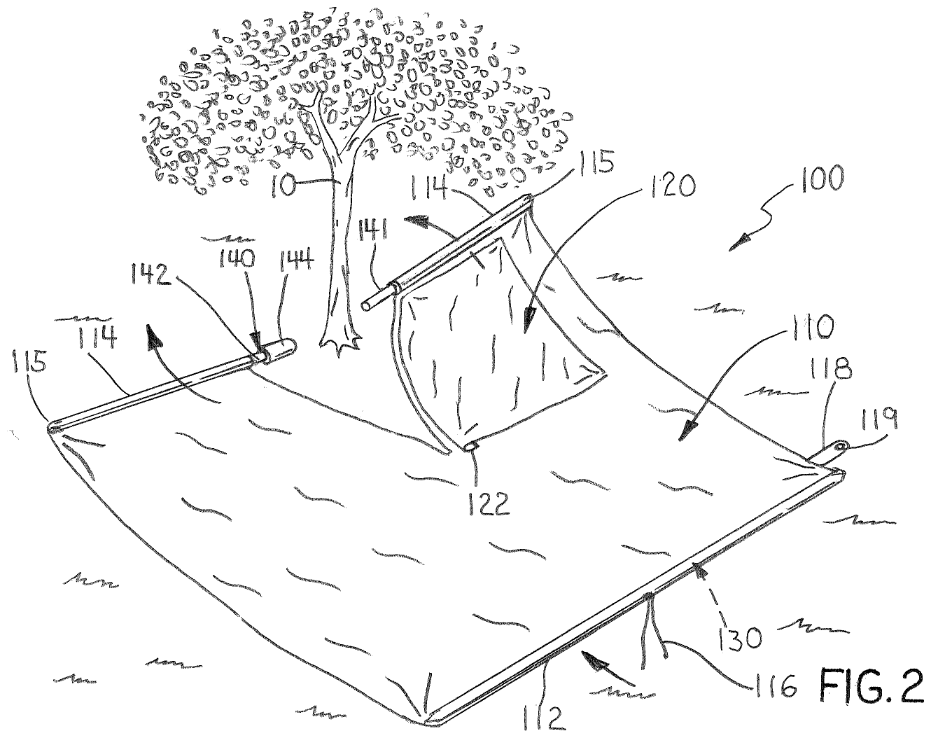

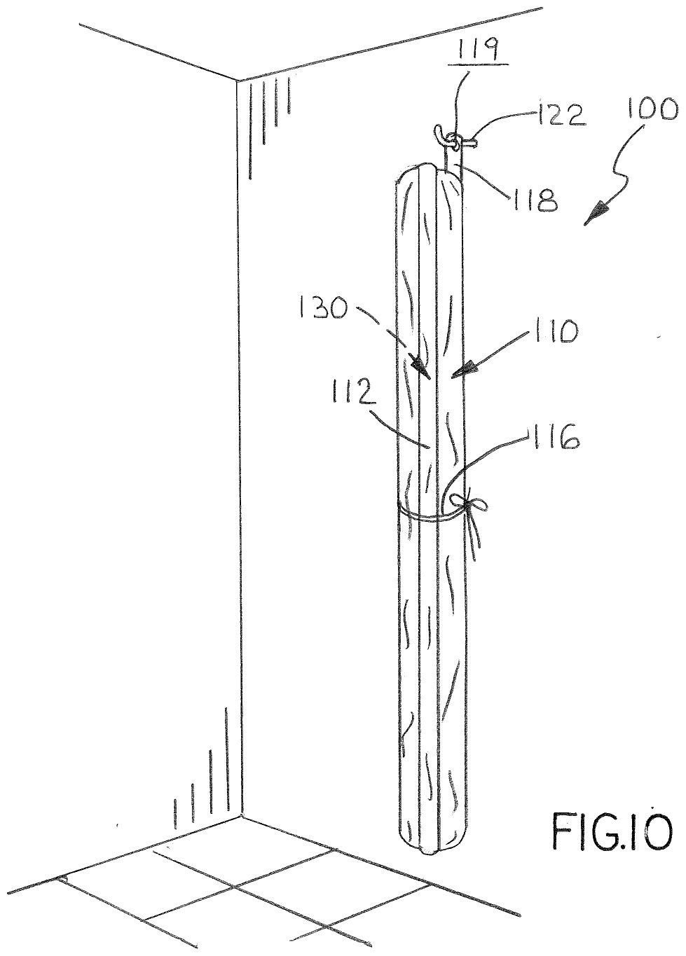

Referring now to the drawings, FIGS. 1-10 illustrate an exemplary embodiment of the ground cover, which is designated generally as reference numeral 100. Ground cover 100 is used to collect and gather leaves and clippings pruned or falling from a tree, bush or plant (illustrated as tree 10) and then depositing those leaves and clippings 12 in another collection container or bin 20. Ground cover 100 is spread flat around the base of tree 10 to collected and gather leaves and clippings 12 (FIGS. 2-9) and rolled up for storage (FIG. 10).

Ground Cover 100 includes a planar a fabric body 110, a cover flap 120, and a pair of side rods 130 and 140. Cover body 110 is constructed of a suitable durable, light weight, moisture repellent cloth, such as a nylon fabric. As shown, cover body 110 is generally square, but may take other shapes and configurations. The peripheral edges of cover body 110 are hemmed and stitched or bonded. Cover body 110 has a single slit 111 that extends to its center. The opposed edges of slit 111 are also hemmed for durability. Slit 111 allows cover body 110 to be wrapped around the trunk or stem of a plant. Draw strings 116 and hang tab 118 are sewn or connected to cover body 110. Hang tab 118 has a hole or grommet 119 for hanging ground cover 100 during storage.

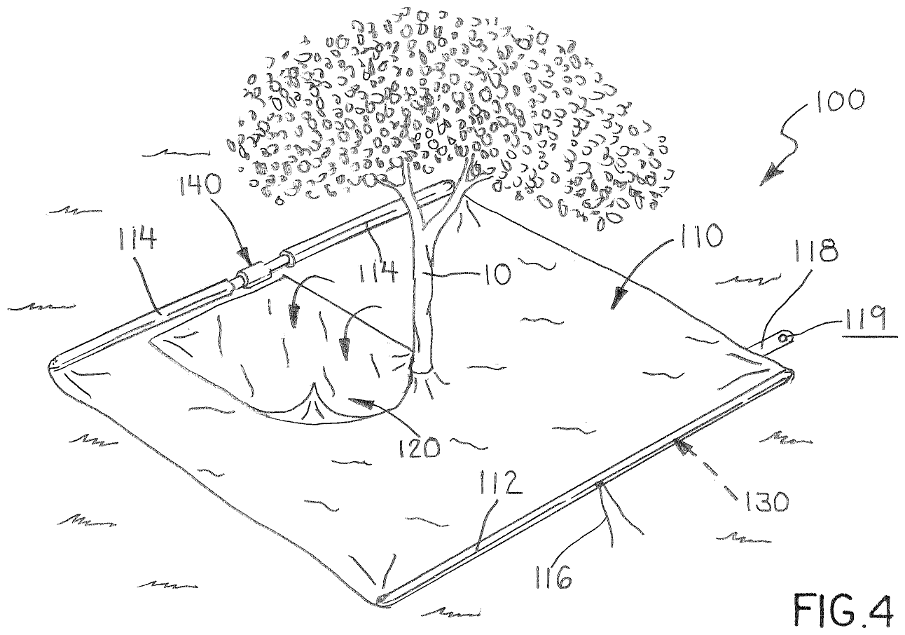

A rectangular cover flap 120 is sewn to cover body 110. As with cover body 110, the peripheral side edges of cover flap 120 are hemmed and stitched. Cover flap 120 has a seamed edge 122 that is sewn or bonded directly to cover body 110 along the length of slit 111. Cover flap 120 folds to lay flat over cover body 110 in two positions, either folded to lie on one side of slit 111 (FIGS. 2, 3, 6) or covering the slit (FIGS. 4, 5 and 7). Two opposed edges of cover body 110 are over lapped to form looped passages or sleeves 112 and 114 receiving side rods 130 and 140 respectively.

Side rods 130 and 140 are lengths of rigid, light weight rod or tubing, such as PVC tubing, that are fitted to opposite sides of cover body 110. Side rod 130 is a single length of rod or tubing, typically PVC tubing disposed within side loop 112. Side rod 140 consists of two lengths of rod or tubing, sections 142 and 146, detachably connected end to end by a coupler 144. Sections 142 and 146 are disposed in side loops 114. Side loops 114 are spaced axially from one another to expose coupler 144.

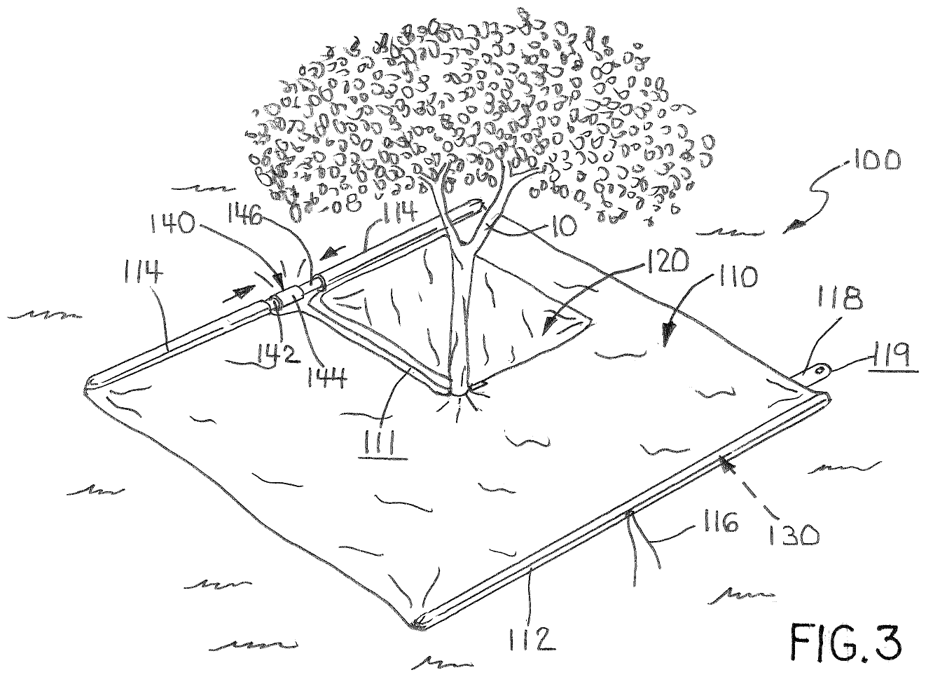

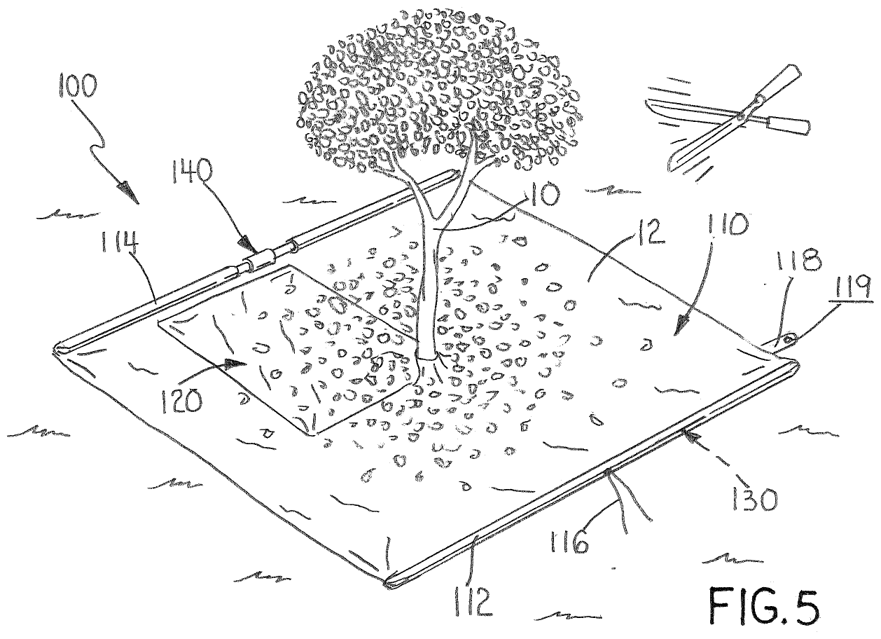

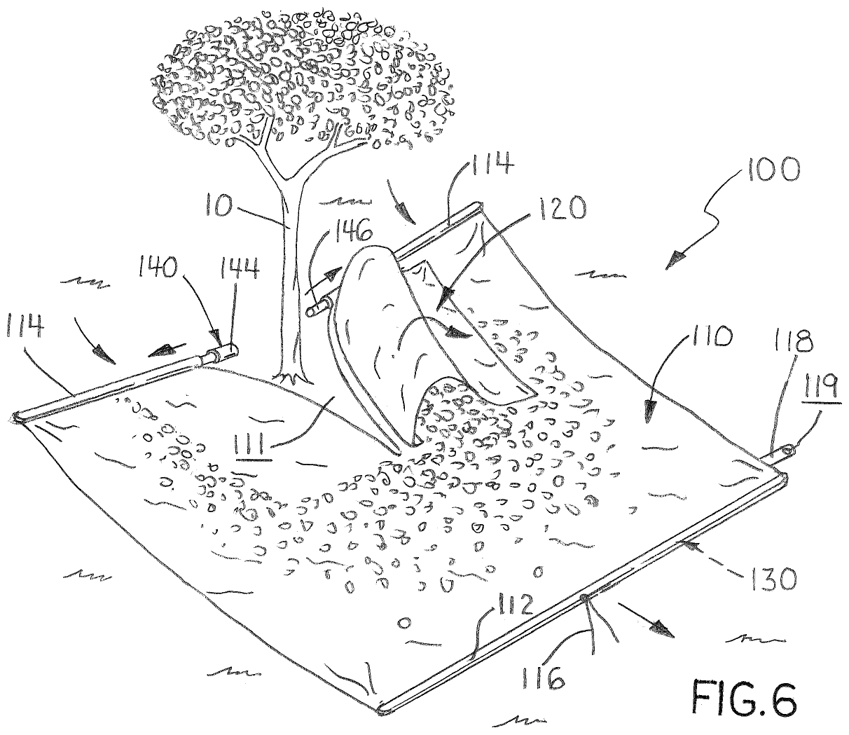

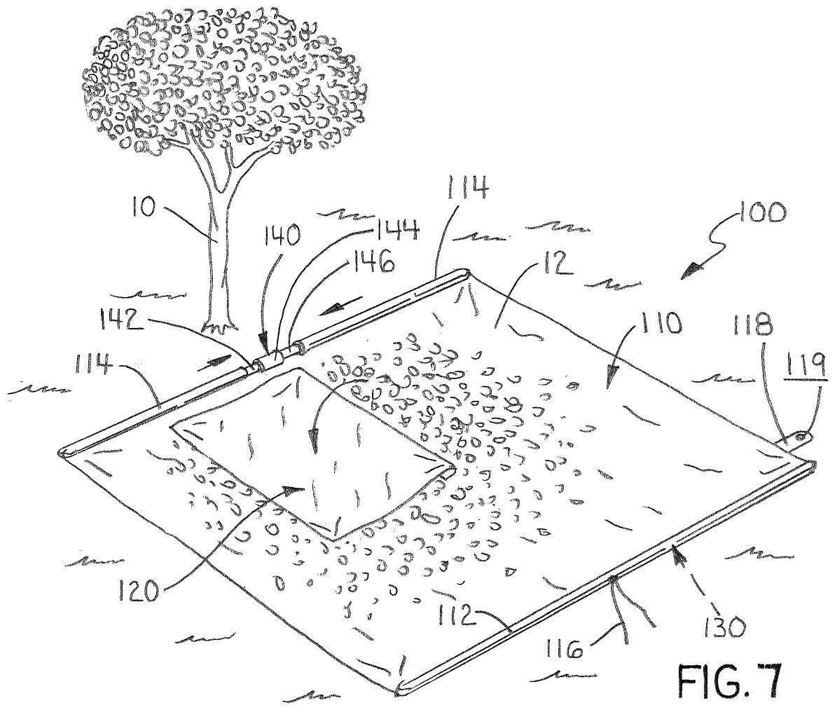

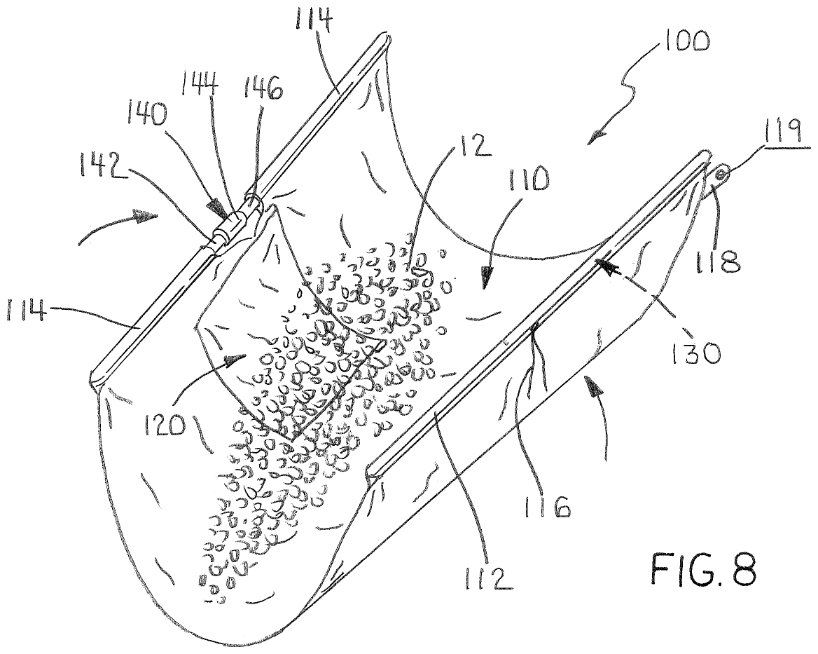

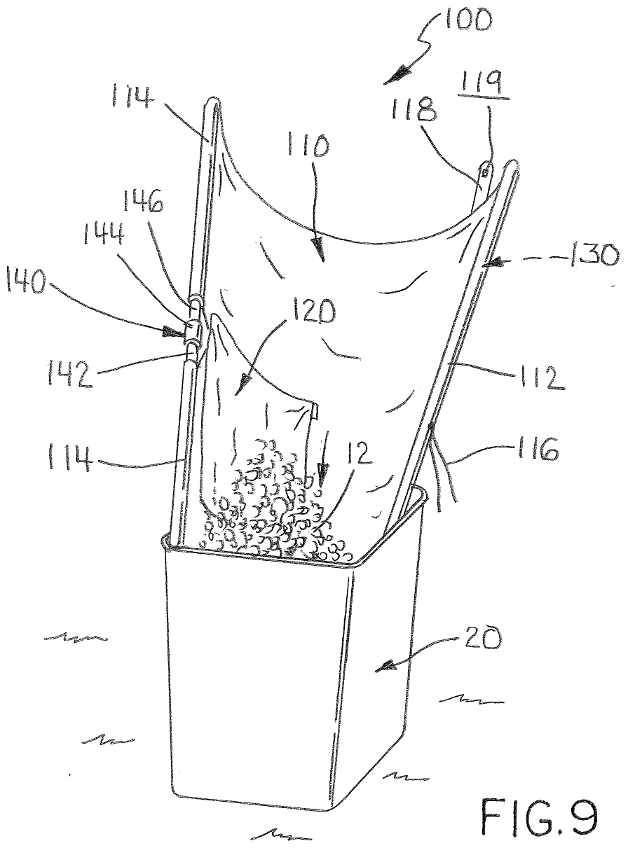

FIGS. 2-10 illustrate the use of ground cover 110 in collecting and gathering leaves and clippings 12 from around tree 10 and depositing the leaves and clipping in a container or bin 10. Cover body 110 is laid flat on the ground around the base of tree 10 (FIG. 2). Slit 111 allows cover body 110 to completely wrap around the base of the plant and lay flat over the ground. Side rod 140 is disconnected and cover flap 120 is folded out of the way to allow cover body 110 to be wrapped around the base of tree 10. Once cover body 110 is in place around tree 10, side rod 140 is connected (FIG. 3) and cover flap 120 is folded over slit 111 (FIG. 4). FIG. 5 shows leaves and clippings 12 falling and collecting on ground cover 100. Once the leaves and clipping are collected, side rod 140 is disconnected and cover flap is folded back to allow cover body 110 to be pulled from around the base of tree 10 (FIG. 6). Once ground cover 100 is pulled from around tree 10, side rod 140 is reconnected and cover flap 120 is folded back over slit 111 to prevent leaves and clipping from falling through slit 111 when ground cover 100 is handled (FIG. 7). With side rod 140 reconnected and cover flap 120 folded over slit 111, side rods 130 and 140 are manually gathered together allowing the collected leaves and clippings 12 to gather inside ground cover 100 (FIG. 8). Ground cover 100 is physically lifted by grasping side rods 130 and 140 to deposit the collected and gathered leaves and clippings 12 into collection container or bin 20 (FIG. 9). When stored, ground cover 100 is rolled up drawing side rod 130 and 140 together and secured by draw strings 116. When rolled up, ground cover 100 can be hung from peg, hook or nail by hang tab 118 (FIG. 10).

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A ground cover for collecting, gathering and depositing leaves and clippings from trees, shrubs and bushes comprising:
a planar cover body made from a fabric material and having two opposed side edges and a slit extending from one side edge into the center of the cover body;
a pliable cover flap made from a fabric material connected to the cover body to fold over the cover body between a first position spaced from the slit in the cover body and a second position overlying the slit in the cover body;
a first side rod having detachable ends thereof fitted to the cover body along the one side edge to allow the cover body to be positioned around the trees, shrubs and bushes; and
a second side rod fitted to the cover body along the opposite of the one side edge.

2. The ground cover of claim 1 wherein the cover body includes a hang tab.

3. The ground cover of claim 1 wherein the cover body includes draw strings.

4. The ground cover of claim 1 wherein the detachable ends of the first side rod are detachably connected end to end by a coupling.
